(19) United States
(12) Patent Application Publication
(10) Pub. No.: US 2008/0228563 A1
(43) Pub. Date: Sep. 18, 2008

(54) REDEMPTION OF REWARD UNITS FOR TRANSACTIONAL ACCOUNTS

(76) Inventors: Samuel Zellner, Dunwoody, GA (US); Jerome Myers, Villa Rica, GA (US)

Correspondence Address: WITHERS & KEYS FOR BELL SOUTH, P. O. BOX 71355, MARIETTA, GA, 30007-1355, US

(21) Appl. No.: 11/460,619

(22) Filed: Jul. 27, 2006

(51) Int. Cl. G06Q 30/00

(52) U.S. Cl. 705/14

(57) ABSTRACT

Reward units accrued for use of a transactional account to pay for purchases are redeemed to cover any cost associated with activities initiated by an account holder where reward units are applicable to those activities. The redemption occurs as an automatic process in response to the account holder initiating the activity and without requiring the account holder to request that redemption occur. Accordingly, the account holder is not required to recall that reward units are applicable for the activity and is not required to request that the reward units be applied to cover any cost associated with the activity.

### TECHNICAL FIELD

Exemplary embodiments are related to transactional accounts and usage of accrued reward units. More particularly, the exemplary embodiments are related to the automatic redemption of reward units accrued for the transactional account.

### BACKGROUND

Transactional accounts, such as credit and debit accounts, frequent usage accounts, etc., are often used to make purchases in place of using cash. As an incentive to use a particular transactional account when making a purchase, the issuer of the transactional account may grant a reward to the holder of the transactional account. The reward may be a monetary amount that is a percentage of the purchase amounts made with the transactional account over a preceding period of time. In other instances, the reward may be non-monetary, such as frequent flyer miles.

At least for non-monetary rewards, the account holder typically must request redemption. For example, when purchasing an airline ticket, the account holder must request that the frequent flyer miles be applied to cover the purchase rather than paying by some other method. This usually requires that the account holder maintain awareness of the frequent flyer miles or other reward units that are available and also remember to request that those reward units be applied to cover the purchase. In certain cases, the account holder may be prompted to utilize the reward units, but this requires that the user interact and respond with the prompt. The account holder is thereby made responsible for taking advantage of the reward units and may be unsatisfied with the transactional account reward system as a result.

### SUMMARY

Embodiments address these issues and others by providing non-monetary reward units where automatic redemption of those reward units occurs upon an account holder initiating an activity to which the reward units correspond. The account holder is thereby relieved of the responsibility for making use of the reward units as they are automatically applied as opposed to being applied only upon the request of the user. One embodiment is a system for providing rewards for use of a transactional account. The system includes a database maintaining a cumulative amount of non-monetary reward units for the transactional account. The system also includes a transactional system that receives a request for an activity by a holder of the transactional account and that generates an indication signal when the activity is relevant to the reward units. The system further includes a processing system that determines a number of reward units for a given purchase where the transactional account is used for payment, that adds the determined number of reward units to the cumulative amount, that receives the indication that an account holder has initiated an activity for which the reward units are applicable, and that automatically decreases the cumulative amount by a number of reward units necessary to the cover the activity without the account holder requesting that reward units be redeemed to cover the activity.

Another embodiment is a computer readable medium having instructions that are executed by a computer. The instructions cause the computer to determine a number of non-monetary reward units for a given purchase where a transactional account is used for payment and to add the determined number of reward units to a cumulative amount maintained in a database. The instructions further cause the computer to receive an indication that an account holder has initiated an activity for which the reward units are applicable and to automatically decrease the cumulative amount by a number of reward units necessary to the cover the activity without the account holder requesting that reward units be redeemed to cover the activity.

Another embodiment is a method of providing rewards for use of a transactional account. The method involves receiving a selection of an item to purchase with non-monetary reward units and determining whether there are adequate non-monetary reward units associated an account of the account holder to cover the purchase of the pre-selected item. When there are in adequate non-monetary reward units available, then the method further involve receiving notification of a purchase amount where the transactional account is used for payment, determining a number of non-monetary reward units to grant based on the purchase amount, and adding the determined number of reward units to a cumulative amount maintained in a database. When there are adequate non-monetary reward units available, then the method involves automatically decreasing the cumulative amount by a number of non-monetary reward units necessary to the cover the purchase of the item without the account holder requesting that reward units be redeemed to cover the activity.

### DESCRIPTION OF THE DRAWINGS

FIG. 1 shows the interconnection of transactional systems with reward processing systems.

FIG. 2 shows entries of databases of a reward processing system relating customers to purchase amounts and to reward units of multiple types.

FIG. 3 shows an operational flow for automatically redeeming reward units on behalf of account holders upon detection of account holder initiated activities.

FIG. 4 shows a screenshot for allowing an account holder to pre-select an item to purchase with reward units.

FIG. 5 shows an operational flow for automatically redeeming reward units on behalf of an account holder who has pre-selected a time to purchase.

### DETAILED DESCRIPTION

Embodiments provide reward systems that provide automatic redemption of reward units without requiring the account holder to request redemption. Activity initiated by the account holder that corresponds to a type of reward units is reported to the reward processing system. The reward processing system then determines whether there are reward units available to cover any cost associated with the activity and then deducts the reward units necessary to cover the cost from the cumulative reward units for the account holder.

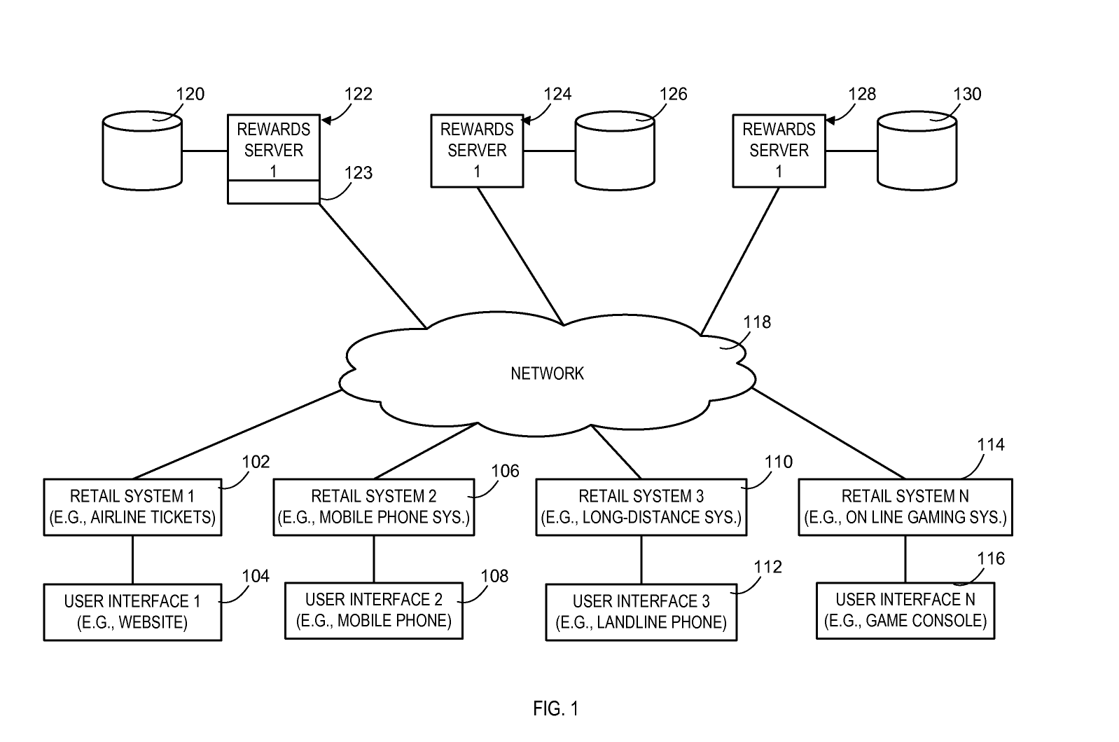

FIG. 1 shows one example of a network system including various transactional and rewards systems. These systems are interconnected via a data network 118 such as a private wide area network or the public Internet. Each transactional system, such as retail system 102, 106, 110, and 114, communicates with a reward server, such as reward server 122, 124, and 128, through the data network 118 to exchange details of account holder activity, such as attempted purchases or on-going uses of services and to receive a return response regarding application of reward units to cover any costs associated with the particular activity of the account holder.

The retail systems include a first retail system 102, for example, an airline ticket sales system. The airline ticket sales system receives a request for airline tickets from a user via a user interface 104, such as a web site, an interactive telephone response system, or a live operator. The request for airline tickets is one example of an activity initiated by an account holder for which reward units may apply. After receiving the request, the airline ticket sales system, without receiving any request by the account holder to redeem reward units and prior to requesting payment, transfers a query including an identifier of the account holder to a corresponding reward system, such as a reward server 122. The airline ticket sales system 102 then awaits a return response from the reward server 122 to determine whether to adjust the costs associated with the account holder activity, or ticket purchase in this example.

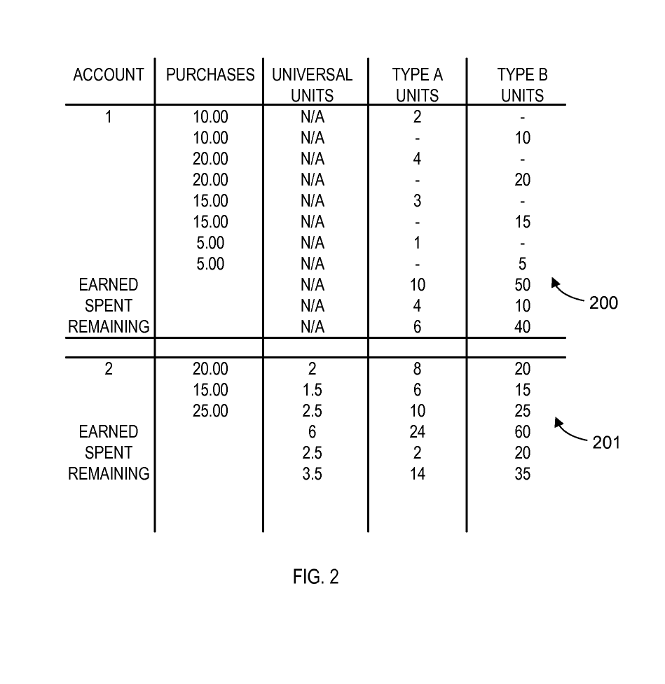

The rewards server 122 accesses an account database 120 that maintains the number of available reward units associated with each account. The rewards server performs a look-up of the account of the identified account holder to find the number of available reward units. For embodiments where the reward server 122 processes reward transactions for multiple retail systems, such as where the reward server 122 corresponds to a particular credit card issuer that has a partnership with various retailers, the reward server 122 determines the applicable reward units based on the particular retailer system submitting the query. This may also be the case where the rewards system processes reward transactions for multiple types of activities per retail system. As discussed below in relation to FIG. 2, the reward system may maintain a universal reward unit count and then determine specific reward units from the universal reward unit count based on a conversion formula. Furthermore, the reward system may maintain a count of separate reward unit types. Additionally, the different reward unit types may be tied to the same total number of universal reward units or may exist independently.

In the example of the airline ticket sales, the reward server 122 determines from database 120 whether there are reward units available for the airline ticket purchase. In one embodiment, the determination may be whether there are enough reward units to cover the airline ticket purchase in total. In another embodiment, the determination may be whether there are any reward units available to cover at least a portion of the airline ticket purchase.

A return response is provided from the reward server 122 to the retail system 102 to indicate whether reward units, in this case frequent flyer miles or tickets or fractions of tickets, are applicable for the current account holder activity. When the return response indicates that there are no reward units available for the activity, in this case the airline tickets, then any cost associated with the tickets is charged to the account holder in the normal manner. However, when the return response indicates that there are reward units available, then either the number of tickets being purchases is accounted for by the reward units or the reward units are utilized to decrease the number of tickets where charges will apply.

When applying the reward units for the activity, the retail system 102 may communicate to the account holder that the reward units are being applied to the activity via the user interface 104, such as by providing a message within a web browser indicating that reward units have been applied. Where the reward units have covered a portion of the activity but some portion of the activity remains to be billed, such as 2 tickets were desired but only 1 ticket reward was available, then the remaining portion of the activity may also be communicated to the account holder and then the remaining cost, i.e., the cost of one of the two tickets, may be charged to the account holder in the normal manner.

As another example of a retail system 106, the retail system 106 may be a mobile telephone system, and the user interface 108 may be the mobile telephone that operates on the mobile telephone system. In such a situation, the account holder may be using the mobile telephone 108 to make telephone calls where the account holder has a limited number of minutes per period of time. Upon the account holder initiating an activity by making a call that causes the total minutes used for the period of time to exceed the limit, the retail system 106 may submit an identifier of the account holder to a reward system such as the reward server 124. The mobile telephone billing system 124 awaits a response from the reward server 124 prior to charging the extra minutes to the account holder. In submitting the query, no request by the account holder for application of the reward units to account for the overages is necessary.

The reward server 124 receives the identifier and performs a look-up of the account holder identifier to determine whether there are reward units, in this case minutes, available to apply to the overage of the query from the mobile phone system 106. The query from the reward server 106 may be on a call-by-call basis. As an alternative, the query may be at the end of the billing period so that a single query for all of the excess minutes is performed as opposed to performing a query for every call that is over the limit. The reward server 124 accesses the available reward units from database 126. The reward units may be universal and may be converted to minutes by a conversion formula. Alternatively, the reward units may be maintained as minutes such that no conversion is necessary when determining the number of reward units necessary to account for the overages.

The return response indicates that either there are reward units to cover at least a portion of the minutes or there are not. If not, then the excess minutes are billed to the account holder in the normal fashion. If there are reward units to account for the excess minutes, then the mobile telephone billing system does not charge for the excess minutes that have been covered. The account holder may be informed of the application of the reward units by sending a message to the mobile phone, such as a short message, upon completion of the call that has exceeded the limit, sending a message at the end of the billing period indicating the total number of excess minutes accounted for by the reward units, and/or by providing notice of the reward units on the monthly billing statement.

As another activity initiated by an account holder, the mobile telephone 108 may be used to access a concierge service of the mobile telephone system. The concierge service may be used for purposes such as obtaining information including telephone numbers, assistance in completing telephone calls, obtaining weather reports, traffic reports, assistance in making purchases, etc. Each of these concierge services may have a cost, and upon the account holder making the telephone call to request the concierge service, the mobile telephone system 106 may submit a query to the reward server 124.

As mentioned above and discussed below in relation to FIG. 2, the database 126 may store reward units as a universal number with a formula used to convert that universal number to different reward unit types. In this example of the mobile phone system, one reward unit type may be minutes for calls in excess of the monthly limit while another reward type may be a number of concierge requests or fraction thereof.

As another example, a retail system 110 may be a landline long-distance telephone system, and the user interface 112 may be a landline telephone. The account holder may initiate an activity for which reward units may apply be placing a long distance telephone call via the long-distance telephone system 110. The long-distance telephone system 110 may query the reward server 128 to determine whether the account holder has reward units for covering at least a portion of the long-distance charges. As with the mobile phone minutes, the query may be on a call-by-call basis or may be at the end of the billing period so that one query applies for the total long-distance minutes accrued for the billing period.

The server 128 performs a look-up of the identifier of the account holder to determine whether there are reward units that apply for the long-distance charges. When the reward server 128 responds to indicate that the account holder has available reward units, the long-distance telephone system 110 then does not charge the account holder for those minutes that are covered. Any remaining minutes are charged to the account holder in the normal manner, as are minutes for calls where no reward units are available.

As yet another example, a retail system 114 may be an online gaming system, and a user interface 116 may be a game console participating in an online game. The account holder may choose to make a purchase within the online game, such as a component or upgrade to a game, and/or charges may accrue based on the time that the game is played. In either case, when the user initiates an activity such as attempting to purchase a component or when beginning participation in an online game, the online system 114 may query one of the reward servers 120, 124, 128 applicable to online gaming without the account holder making a request for reward units to be applied.

The reward server performs a look-up in the associated database for the applicable reward units. The reward server provides a return response to indicate that the reward units are or are not available. When reward units are available, the online gaming system 114 does not apply any charges for the purchase or time of game play. The online gaming system 114 may provide notice to the account holder by posting a message directly to the gaming console 116 for display. When reward units are not available, the online gaming system 114 applies the charges in the normal manner.

According to an exemplary embodiment, the reward servers of FIG. 1 are computers that implement instructions to perform the reward processing tasks. The instructions being implemented by the servers may exist on various forms of computer readable media 123 accessible by each server, including but not limited to electronic memory, optical, electronic, or magnetic storage media, and via network connectivity including wired and wireless connections. For simplicity of illustration, a computer readable medium 123 is only explicitly depicted as being associated with reward server 122. It should be appreciated, however, that each reward server may have a computer readable medium associated with it.

While various examples of account holder activities have been discussed in relation to FIG. 1, it will be appreciated that these examples are provided solely for the purposes of example. There are many other examples as well, such as when an account holder places an order for food at a restaurant, reward units such as number of available meals, may be applied for the purchase to reduce or eliminate the charges for the food.

FIG. 2 shows an account of one example of account entries 200 and 201 in a database of a reward processing system. The first account entries 200 show two different sets of reward units, for type A and for type B. For account 1, the reward units for type A and for type B are accrued separately such that there are no universal reward units that are applicable. For example, reward units of type A may be frequent flyer miles while reward units of type B may be mobile phone minutes. Account 1 has eight purchases that have been received from various retail systems where the account holder has made purchases using a particular transactional account for which reward units are applicable. In this example, for account 1 each dollar spent for purchases relevant to type A reward units results in two tenths of a reward unit while each dollar spent for purchases relevant to type B reward units results in 1 reward unit. Account 1 has earned a total of 10 type A reward units and 50 type B reward units. Account 1 has spent 4 type A reward units and 10 type B units such that 6 type A units and 40 type B units are available for covering activities.

FIG. 2 also shows an account of another example of database entries 201 of a second account. This account 2 shows universal reward units, type A reward, units and type B reward units. For the account 2, type A reward units and type B reward units are tied together rather than being distinct. Type A reward units are found based on a formula applied to the universal reward units while type B reward unites are found based on another formula applied to the universal reward units. In this example, each dollar spent is worth a tenth of a universal reward unit. Type A reward units are equal to four times the universal reward unit while type B reward units are equal to 10 times the universal reward unit. As an example, type A reward units may be numbers of concierge service purchases while type B reward units may be mobile phone minutes.

For the account 2, when a purchase is made, the universal reward units increase, and the units available for type A and for type B are not separately redeemable but are linked. When reward units are used for a type A activity, then reward units available for type B activities are also reduced. As shown, 6 universal reward units have been earned, which equates to 24 type A units and 60 type B units. Two type A units have been spent while 20 type B units have been spent. There are a resulting 3.5 universal reward units left, which equates to either 14 type A units or 35 type B units.

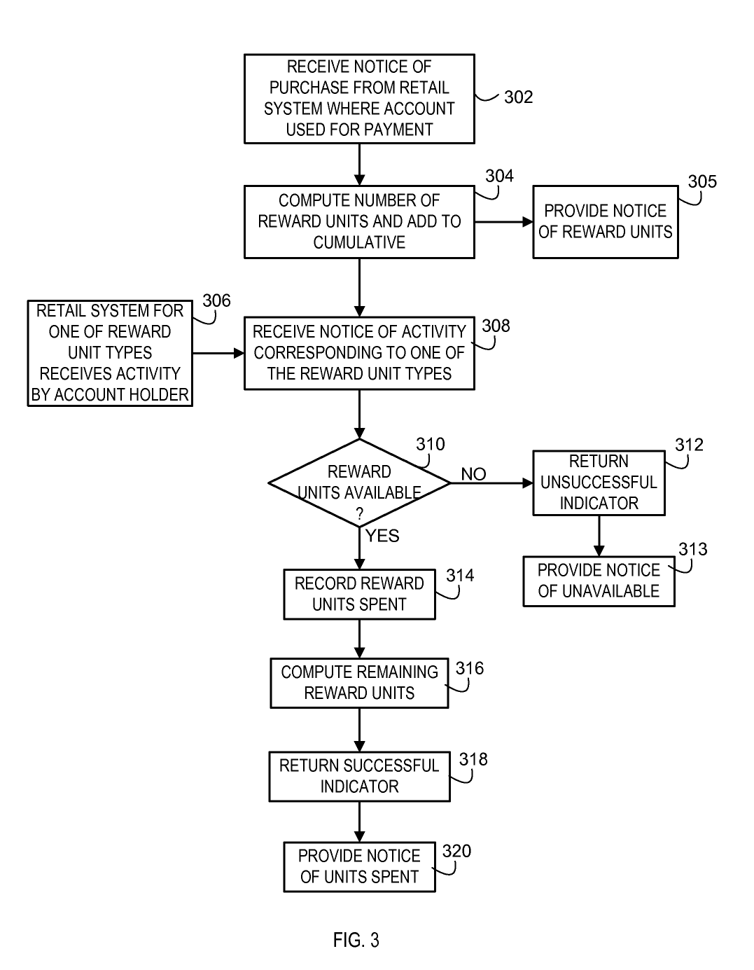

FIG. 3 shows one example of the operational flow of a transactional system in communication with a reward processing system. The operational flow begins at operation 302, e.g., a purchase operation, where an account holder uses the transactional account for which reward units are applicable to make a purchase, e.g., airline tickets. The reward processing system receives an indication of the purchase amount and, where applicable, the type of reward units for which the purchase applies. At computation operation 304, the reward processing system computes the number of reward units that are earned based on the purchase amount, including universal reward units and any reward units of other types where applicable. At this point, a notification may be generated to inform the account holder of the additional points that have been earned as well as the new cumulative total that has been achieved as a result at notification operation 305. The notification may take the form of an electronic message such as an email, a line item entered on a paper statement mailed to the account holder, a message posted on an electronic information board, such as a lobby screen of an on-line game, and so on.

Subsequently, the account holder initiates an activity that corresponds to one of the types of reward units being accrued within the reward processing system. For example, the account holder may initiate purchase of airline tickets. The retail system where the activity is initiated receives the initiation of that activity at operation 306, and the transactional system submits a query to the reward processing system without the account holder requesting that application of reward units should be attempted. The reward processing system then receives the query that includes the notification of the activity and the identification of the account holder at notice operation 308.

Upon receiving notice of the activity, the reward processing system then makes a determination as to whether there are any reward units that are applicable to the activity for the account holder at query operation 310. In one embodiment, query operation 310 determines whether there are reward units for covering the entire cost associated with the activity. In another embodiment, query operation 310 determines whether there are any reward units for covering at least a portion of the cost associated with the activity. Furthermore, in certain embodiments, such as for online gaming, this may be an repetitive process during gameplay whereby as time or available lives in the game are used up, the system continues to check for available reward units to allow gameplay to proceed without requiring the user to provide some other form of payment. If query operation 310 finds inadequate reward units, then a return response is provided as an unsuccessful indicator at return operation 312. The retail system may thereafter charge the account holder as normal. In doing so, a notice of the unavailable reward units may be presented to the user at notification operation 313, such as via an electronic message to an email account or short message to a mobile phone or a dialog box that pops up on the display screen during online gaming. A message may be posted on a display screen of the retail system to provide immediate notification to the user that the reward units are unavailable and that a different form of payment is necessary to complete the purchase of a good or to have the service continue.

When query operation 310 finds that there are adequate reward units available for the indicated activity, then the number of reward units that are spent to cover all or a portion of the activity are recorded within the database at record operation 314. The reward processing system then computes the remaining reward units based on those earned and those spent thus far at computation operation 316. Finally, the reward processing system returns a successful indicator to the retail system at return operation 318. The successful indicator may specify that the activity is entirely covered, or in the alternative embodiment, the successful indicator may specify how much of the activity is covered by reward units. For example, if the activity was a long-distance call of 20 minutes but only 10 minutes worth of reward units were available, then the successful indicator may indicate that 10 minutes are covered by the reward units so that the retail system may then determine that a remaining 10 minutes are to be billed to the account holder. The account holder thereby benefits from the accrual of reward points without having to remember that reward points may be applicable to a given activity and without having to request that the applicable reward points be applied.

At this point, a notice may be provided to the account holder to indicate that reward units have been applied at notification operation 320. The notification may indicate the total number of reward points used to complete the transaction and may also provide a notice as to the remaining number of reward points that are available for future transactions.

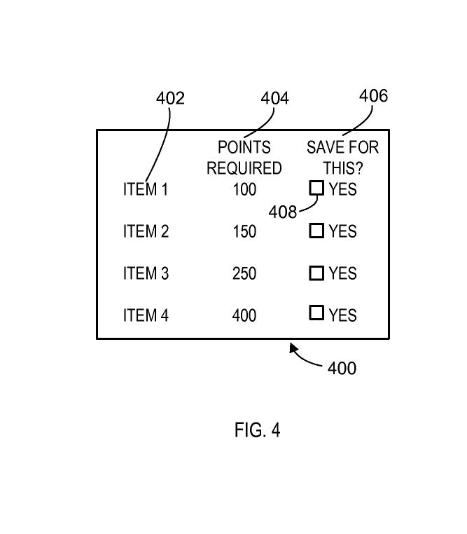

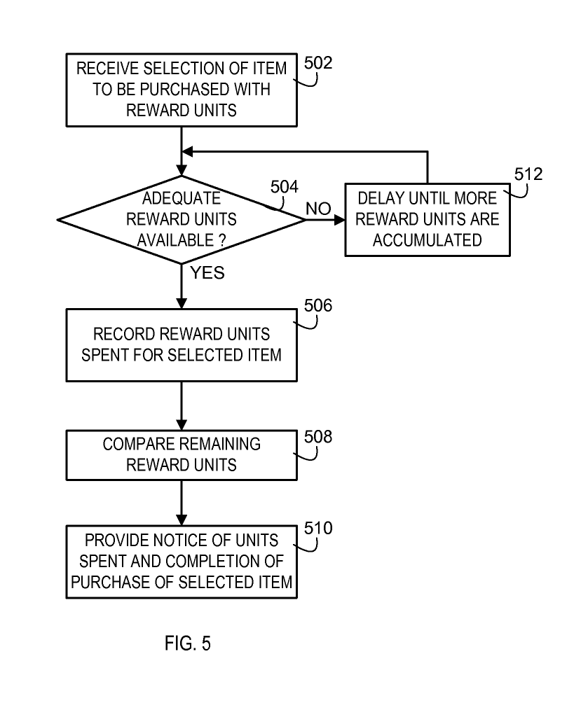

In addition to the account holder entering into transactions where reward units are automatically applied on his or her behalf when available, the rewards server of interest may provide the user with the ability to choose a good or service in advance or earning the reward units. For example, the reward server may provide a user interface, such as a web page 400 of FIG. 4 displayed in a web browser of the account holder, that provides the account holder with options to choose in advance. As shown, the web page 400 includes a list 402 of items to be purchased with reward points. Column 404 may indicate the reward units needed for each item, and column 406 may provide a control 408 such as a checkbox that the user may select. The reward server performs logical operations as shown in FIG. 5 to automatically redeem reward units to purchase the selected item.

The pre-selected items may be similar to those discussed above. For example, the user may select mobile phone minutes so that upon accrual of an adequate number of reward units, mobile phone minutes are purchased with those reward units. As another example, the user may select a concierge service, where a number of calls to the concierge service are purchased once an adequate number of reward units have accrued. As yet another example, the user may select a virtual item of an online video game such that the purchase is of the virtual item is made with those reward units once they have adequately accrued.

At selection operation 502 of FIG. 5, the rewards server receives a selection by the account holder of items from the list. At query operation 504, the rewards server detects whether there are adequate rewards units available to complete the purchase of the selected item. If not, then the rewards server waits until there are additional reward units accrued for this account holder at delay operation 512. As discussed above, additional reward units may be accrued by the user making a purchase using the transactional account to which the rewards server corresponds.

Upon query operation 504 detecting that adequate reward units are available, then the number of reward units that are spent to cover the purchase of the pre-selected item are recorded within the database at record operation 506. The reward processing system then computes the remaining reward units based on those earned and those spent thus far at computation operation 508. At this point, a notice may be provided to the account holder to indicate that reward units have been applied to complete the purchase of the pre-selected item at notification operation 510. The notification may indicate the total number of reward points used to complete the transaction and may also provide a notice as to the remaining number of reward points that are available for future transactions including the purchase of additional pre-selected items.

While the invention has been particularly shown and described with reference to various exemplary embodiments thereof, it will be understood by those skilled in the art that various other changes in the form and details may be made therein without departing from the spirit and scope of the invention.

What is claimed is:

1. A system for providing rewards for use of a transactional account, comprising:
a transactional system that receives a request for an activity by a holder of the transactional account and that generates an indication signal when the activity is relevant to the reward units; and
a processing system that determines a number of reward units for a given activity where the transactional account is used for payment, that adds the determined number of reward units to a cumulative amount maintained for the account holder, that receives the indication that the account holder has initiated an activity for which the reward units are applicable, and that automatically decreases the cumulative amount by a number of reward units necessary to the cover the activity without the account holder requesting that reward units be redeemed to cover the activity.

2. The system of claim 1, wherein the reward units are minutes for mobile telephone usage and wherein the activity is a mobile telephone call.

3. The system of claim 1, wherein the reward units are numbers of telephone calls to be made to a concierge service and wherein the activity is a call to the concierge service.

4. The system of claim 3, wherein the concierge service includes providing directory information, weather reports, and traffic reports.

5. The system of claim 1, wherein the reward units are purchase points within an online video game and wherein the activity is a purchase made within the online video game.

6. The system of claim 1, wherein the reward units are minutes for long distance telephone calls and wherein the activity is a long distance telephone call.

7. The system of claim 1, wherein the cumulative reward units are general units and wherein the processing system converts the general units to specific units corresponding to the activity when automatically decreasing the reward units to cover the activity.

8. The system of claim 7, wherein converting the general units to specific units comprises utilizing a formula that equates a number of general units to a number of specific units for a particular activity.

9. A computer readable medium having instructions that are executed by a computer to perform acts comprising:
receiving a request for an activity by a holder of the transactional account;
generating an indication signal when the activity is relevant to the reward units;
determining a number of reward units for a given activity where the transactional account is used for payment;
adding the determined number of reward units to a cumulative amount maintained for the account holder;
receiving the indication that the account holder has initiated an activity for which the reward units are applicable; and
automatically decreasing the cumulative amount by a number of reward units necessary to the cover the activity without the account holder requesting that reward units be redeemed to cover the activity.

10. The computer readable medium of claim 9, wherein the cumulative reward units are general units and wherein the acts further comprise converting the general units to specific units corresponding to the activity when automatically decreasing the reward units to cover the activity.

11. The computer readable medium of claim 10, wherein converting the general units to specific units comprises utilizing a formula that equates a number of general units to a number of specific units for a particular activity.

12. The computer readable medium of claim 9, wherein the reward units are numbers of concierge requests of a mobile telephone concierge service, and wherein the activity is a request to the concierge service.

13. The computer readable medium of claim 9, wherein the reward units are minutes for mobile telephone usage and wherein the activity is a mobile telephone call.

14. The computer readable medium of claim 9, wherein the reward units are minutes for long distance telephone calls and wherein the activity is a long distance telephone call.

15. A method of providing rewards for use of a transactional account, comprising:
receiving a request for an activity by a holder of the transactional account;
generating an indication signal when the activity is relevant to the reward units;
determining a number of reward units for a given activity where the transactional account is used for payment;
adding the determined number of reward units to a cumulative amount maintained for the account holder;
receiving the indication that the account holder has initiated an activity for which the reward units are applicable; and
automatically decreasing the cumulative amount by a number of reward units necessary to the cover the activity without the account holder requesting that reward units be redeemed to cover the activity.

16. The method of claim 15, wherein the cumulative reward units are general units and wherein specific units are applicable to the purchase of the pre-selected item, the method further comprising:
converting the general units to specific units corresponding to the purchase of the pre-selected item when automatically decreasing the reward units to cover the purchase.

17. The method of claim 16, wherein converting the general units to specific units comprises utilizing a formula that equates a number of general units to a number of specific units for purchase of the pre-selected item.

18. The method of claim 15, wherein the activity is mobile phone usage and wherein the reward units are minutes for mobile telephone usage.

19. The method of claim 15, wherein the activity is a call to a concierge service and wherein the reward units are numbers of telephone calls to be made to the concierge service.

20. The method of claim 15, wherein the activity is selection of a virtual item of an online video game and wherein the reward units are purchase points within the online video game.
